(19) United States
(12) Patent Application Publication
(10) Pub. No.: US 2024/0015155 A1
(43) Pub. Date: Jan. 11, 2024

(54) NETWORK ACCESS CONTROL OF AUDIO CAPTURE DEVICE

(71) Applicant: Comcast Cable Communications, LLC, Philadelphia, PA (US)

(72) Inventors: Christopher Stone, Newtown, PA (US); Gary Michael Rekstad, JR., Philadelphia, PA (US)

(21) Appl. No.: 17/859,738

(22) Filed: Jul. 7, 2022

(51) Int. Cl. H04L 9/40; G10L 15/22

(52) U.S. Cl. CPC H04L 63/10; G10L 15/22; G10L 2015/223

(57) ABSTRACT

A voice controlled device may be blocked from accessing a network. Another computing device may receive audio data comprising a voice command associated with controlling the voice controlled device. If a trigger condition for unblocking network access is detected, the computing device may send data to a network device to cause the network device to unblock network access. The network access may be blocked again if a triggering condition for blocking network access is satisfied.

### BACKGROUND

Audio capture devices, such as voice controlled devices, allow users to provide commands and information without having to use conventional input devices, such as keyboards, which may be slow and cumbersome to use. Audio capture devices, however, create privacy issues for many users. Audio may be captured and sent to a server in situations that are not intentional or that violate the expectations of the users. Thus, there is a need for more sophisticated control of audio capture devices.

### SUMMARY

Methods and systems for controlling audio capture devices are disclosed. An untrusted audio capture device, such as a voice controlled device with a virtual assistant, may be controlled at a premises using network access control. The untrusted audio capture device may be blocked from accessing a network at a premises. Any messages transmitted by the untrusted audio capture device based on a user command, such as an audio command spoken by the user, may be stored in a buffer. A trusted audio capture device at the premises may be leveraged to capture audio from the user. The trusted audio capture device may analyze the audio to determine if the user is speaking to the untrusted audio capture device. The trusted audio capture device may send a message to a network device configured to control network access, causing the untrusted audio capture device to be temporarily unblocked from accessing the network. If the untrusted audio capture device is unblocked, any messages from the untrusted device that were stored in the buffer may be sent via the network.

A variety of other conditions may be used to trigger unblocking of the untrusted audio capture device, such as a user walking into an area in which the trusted audio capture device is located. Similarly, different conditions may also trigger blocking of the untrusted audio capture device, such as a user walking out of an area or other detected user behavior indicating the user is done using the untrusted audio capture device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2A shows an example premises.

FIG. 2B shows an example premises.

FIG. 3 shows an example method.

FIG. 4 shows an example method.

FIG. 5 shows an example method.

FIG. 6 shows an example computing device.

### DETAILED DESCRIPTION OF ILLUSTRATIVE EMBODIMENTS

Smart home devices, such as third party voice controlled devices, are typically “always listening,” which makes some users uncomfortable. Even if a user enables a mute button on a smart device, there may still be an uneasy feeling that the device is still listening. Requiring the user to physically press a button to disable and enable the device's listening capabilities is also inconvenient. The disclosed methods and systems enable transmissions to and from a smart device to be blocked until a trigger word (e.g., wake word) is detected by a more trusted device in the home. This approach provides another level of security and privacy for users.

The disclosed methods and systems may leverage the use of an additional listening device at the premises (e.g., as well as other devices) to detect audio commands (e.g., voice commands, spoken commands, etc.) for a voice controlled device, such as a third party voice controlled device. A network device, such as a gateway device, may block network access to the voice controlled device. If network access to the voice controlled device is blocked, any messages that the voice controlled device may send or receive may be buffered. The additional listening device may detect a command for the voice controlled device from a user by processing captured audio. If a trigger word associated with the voice controlled device is detected, then the network device may be updated to unblock network access for the voice controlled device. With the network access unblocked, messages sent by the voice controlled device, and any messages that may have been buffered, may be sent to an external server and/or other devices (e.g., local to the premises, external to the premises). The network device may be updated (e.g., after a time period, or other trigger condition) to return to blocking network access of the voice controlled device.

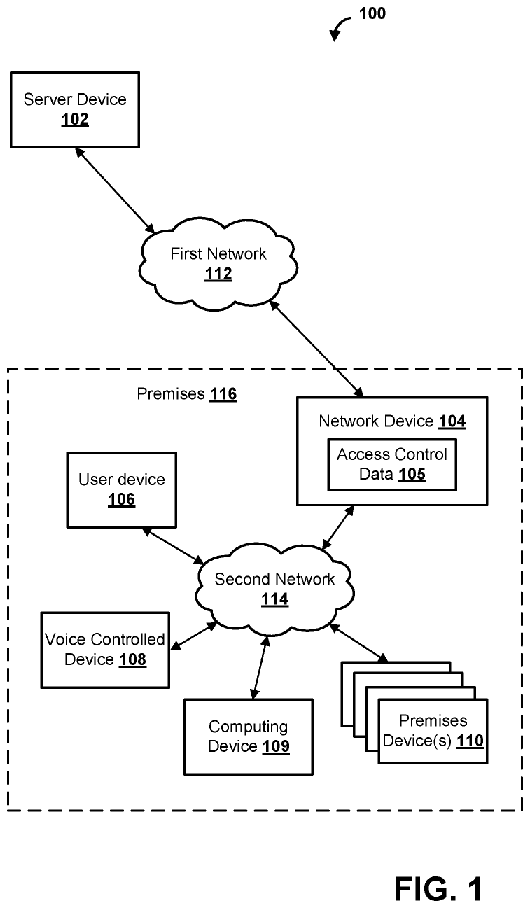

FIG. 1 shows a block diagram of an example system 100. The system 100 may comprise a server device 102, a network device 104 (e.g., or gateway device, modem, router, cable modem), a user device 106, a voice controlled device 108 (e.g., an untrusted device, a third party device, a first computing device, a first listening device, a first audio capture device), a computing device 109 (e.g., a trusted device, a second listening device, a second voice controlled device, a second audio capture device), one or more premises devices 110, or a combination thereof. It should be noted that while the singular term device is used herein, it is contemplated that some devices may be implemented as a single device or a plurality of devices (e.g., via load balancing). The server device 102, the network device 104, the user device 106, the voice controlled device 108, the computing device 109, the one or more premises devices 110, may each be implemented as one or more computing devices. Any device disclosed herein may be implemented using one or more computing nodes, such as virtual machines, executed on a single device and/or multiple devices.

The server device 102, the network device 104, the user device 106, the voice controlled device 108, the one or more premises devices 110, may be configured to communicate via one or more networks, such as a first network 112 (e.g., a wide area network) and one or more second networks 114 (e.g., one or more local area networks). The first network 112 may comprise a content distribution and/or access network. The first network 112 may facilitate communication via one or more communication protocols. The first network 112 may comprise fiber, cable, a combination thereof. The first network 112 may comprise wired links, wireless links, a combination thereof, and/or the like. The first network 112 may comprise routers, switches, nodes, gateways, servers, modems, and/or the like.

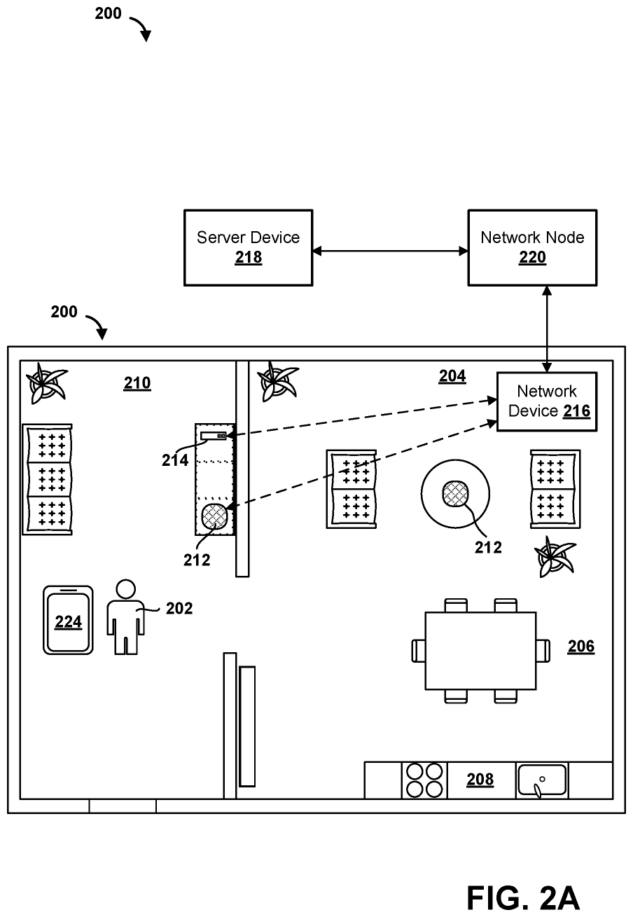

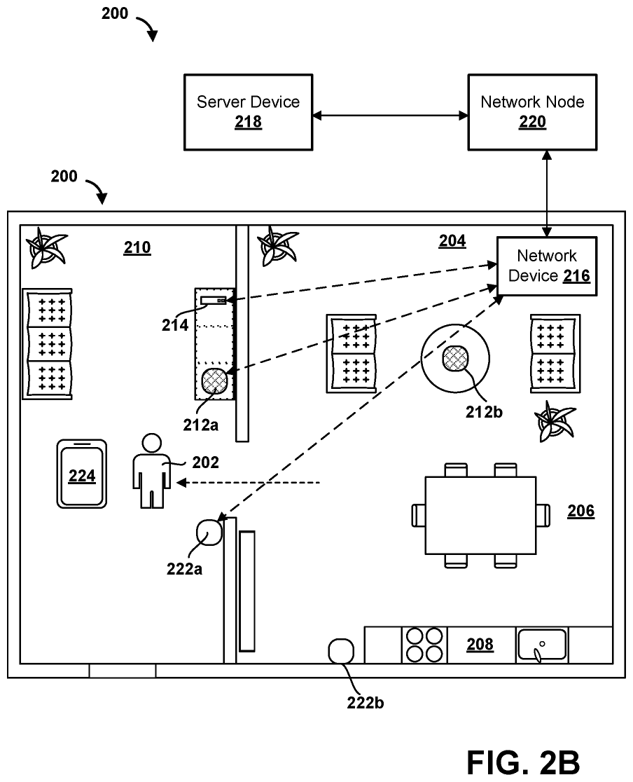

The one or more second networks 114 may comprise one or more networks in communication with the network device 104, the voice controlled device 108, the computing device 109, or a combination thereof. In some scenarios, the network device 104 and the computing device 109 may be implemented as a single device. In other scenarios, the computing device 109 may be a stand-alone device or integrated into another device, such as a television, remote control, set top box, media streaming device, user device (e.g., mobile phone, tablet), and/or the like. The one or more second networks 114 may comprise one or more networks at a premises 116. The premises 116 may be a customer premises. The premises 116 may include an area within a coverage range (e.g., wireless range) of the network device 104 (e.g., or voice controlled device 108). The premises 116 may comprise a property, dwelling, terminal, building, floor, and/or the like. The premises 116 may comprise different rooms, walls, door, windows, and/or the like (e.g., as shown in FIG. 2A-B). The user device 106 may move within the premises 116 and/or outside of the premises 116.

The network device 104 may comprise a computing device, an access point (e.g., wireless access point), a router, a modem, device controller (e.g., automation controller, security controller, premises health controller, content device controller) a combination thereof, and/or the like. The network device 104 may be configured to communicate using the one or more second networks 114 at the premises 116. The network device 104 may be configured to implement one or more services associated with the server device 102 (e.g., or with the premises 116, a user account), such as a content service, a premises service, a voice controlled service, an automation service, a security service, a health monitoring service, or a combination thereof.

The one or more premises devices 110 may be located at the premises 116. The one or more premises devices 110 may comprise one or more of a camera, a sensor, a security system, a security controller, a gateway device, a smoke detector, a heat sensor, infrared sensor, infrared emitter, infrared camera, a door sensor, a motion sensor, a window sensor, a thermostat, a microphone, a personal assistant, a door lock, an irrigation device, or a combination thereof. The one or more premises devices 110 may be configured to generate premises data. The premises data may comprise a sensor state, a setting, audio, video, images, text information, premises mode, or a combination thereof. The one or more premises devices 110 may be configured to send the premises data to the server device 102, the user device 106, the network device 104, the voice controlled device 108, the computing device 109, or a combination thereof. The premises data may be used as a basis to detect location of a user (e.g., room within a premises), recognize a user, determine user intent (e.g., about blocking network access to the voice controlled device 108).

The server device 102 may be configured to provide one or more services, such as account services, application services, network services, content services, or a combination thereof. The server device 102 may comprise services for one or more applications on the user device 106. The server device 102 may generate application data associated with the one or more application services. The application data may comprise data for a user interface, data to update a user interface, data for an application session associated with the user device 106, and/or the like. The application data may comprise data associated with access, control, and/or management of the premises 116. The application data may comprise the premises data, updates to the premises data, and/or the like.

The server device 102 may be configured to determine to send information (e.g., configuration settings, notifications, information about the premises) to the user device 106, the network device 104, or a combination thereof. The server device 102 may comprise information rules associating various values, patterns, account information, and/or the like with corresponding information. The server device 102 may detect a change in the premises data from the one or more premises devices. The server device 102 may analyze the premises data and determine that an information rule is triggered. The information may be sent to the user device 106 based on the information rule being triggered and/or satisfied. The information may comprise at least a portion of the premises data, such as an image, video, sensor state (e.g., motion detected, window open, window closed, door open, door closed, temperature, measured particle level, smoke detected, heat detected) and/or the like. The information may comprise a configuration setting of the network device 104, the voice controlled device 108, the user device 106, the one or more premises devices 110.

The server device 102 may comprise services for managing the computing device 109. The server device 102 may comprise a registry for computing devices 109 at a plurality of premises. The computing device 109 may be configured to send data (e.g., audio, video, commands) captured and/or otherwise determined at the premises 116.

The computing device 109 may be any device configured to capture audio data, video data, sensor data, or a combination thereof. The computing device 109 may comprise a remote control, such as a hands free controller, a voice controller, a controller of a media device (e.g., television, streaming device, set top box). The computing device 109 may be used to control one or more other devices at the premises. The computing device 109 may comprise a smart speaker, such as a device comprising a speaker, a computer processor (e.g., or micro-controller), and a microphone. The computing device 109 may be configured to receive voice commands from users at the premises 116. Voice commands may comprise any command, such as buying a product, adding an item to a list, navigating a content menu, playing content (e.g., audio, video), providing an answer to a question (e.g., via querying a search engine), and/or the like.

The voice controlled device 108 may be configured to receive audio data. The voice controlled device 108 may comprise one or more microphones, such as an array of microphones. The voice controlled device 108 may be configured to receive the audio data by capturing the audio data using the one or more microphones. The voice controlled device 108 may comprise a smart speaker, such as a device comprising a speaker, a computer processor (e.g., or micro-controller), and a microphone. The voice controlled device 108 may be configured to receive voice commands from users at the premises 116. Voice commands may comprise any command, such as buying a product, adding an item to a list, navigating a content menu, playing content (e.g., audio, video), providing an answer to a question (e.g., via querying a search engine), and/or the like. The voice controlled device 108 may be configured to receive audio data. The voice controlled device 108 may comprise one or more microphones, such as an array of microphones. The voice controlled device 108 may be configured receive the audio data by capturing the audio data using the one or more microphones.

The voice controlled device 108 may be an untrusted device, such as a third party device. The computing device 109 may be a trusted device, such as a device managed by a service provider (e.g., network service provider, content service provider). The computing device 109 (e.g., and/or other devices at the premises 116) may be used to selectively block and unblock network access of the voice controlled device 108 to the first network 112. Whether a device is “trusted” or “untrusted” may be determined based on user input indicating whether a device is trusted or untrusted. Devices may be trusted or untrusted based on the device relationship to a service provider. If the device is managed by (e.g., registered to, controlled by) the service provider, the device may be trusted. If the device is not managed by (e.g., registered to, controlled by) the service provider, the device may be untrusted.

The network device 104 may be configured to determine to block the voice controlled device 108. The determination may be made based on receiving (e.g., from the computing device 109, the user device 106, the server device 102) an instruction (e.g., or indication, message, notification) to block the voice controlled device 108. The instruction to block the voice controlled device 108 may comprise an instruction from the user device 106 to pause (e.g., or block) access, of the voice controlled device 108, to the first network 118. The instruction to block the voice controlled device 108 may comprise an instruction from the computing device 109 to block the voice controlled device 108. The instruction to block the voice controlled device 108 may be based on trigger condition for blocking the voice controlled device 108. The network device 104 may determine to block the voice controlled device 108 without receiving an instruction, such as if the triggering condition for blocking the voice controlled device 108 is satisfied and/or detected by the network device 104.

The trigger condition for blocking the voice controlled device 108 may comprise one or more of completion of an operation by a user, detection of music turning off, detection of the user leaving an area (e.g., room, floor) of the premises, a light turning off, a door opening (e.g., or closing, locking,), a change of a mode of a premises system (e.g., away mode, sleep mode, active mode), an arming of the premises system, or a combination thereof.

The trigger condition for blocking the voice controlled device 108 may comprise a time condition, such as a time condition indicated in a schedule. A user may set a schedule indicating time windows (e.g., or time periods) for blocking voice controlled devices 108, a start time to block the voice controlled device 108, and end time to unblock the voice controlled device 108, a duration period to block the voice controlled device 108, or a combination thereof.

The trigger condition for blocking the voice controlled device 108 may be based on content viewership data. The trigger condition may comprise detection of a user watching a particular type of content (e.g., sports content, news content). One or more of the server device 102, the network device 104, the user device 106, the computing device 109, the premise device 110, or other device (e.g., streaming device, set top box, television) may detect that the user is watching the particular type of content. For example, if the user requests the content (e.g., changes to the channel, requests a content stream), then the trigger condition may be detected. The device detecting the content and/or detecting the trigger condition may cause the voice controlled device 108 to be blocked.

The trigger condition for blocking the voice controlled device 108 may comprise detection of a particular user. A user may be detected based on selection of a profile on a content device, detection via a camera, and/or the like. A primary user may choose to block a friend or a member of the household from using the voice controlled device 108. The primary user may also choose to block a type of user (e.g., child, secondary user). The primary user can identify the banned user in a video and/or image from one of the premises devices 110. Subsequently, if video captures the user in the room in which the voice controlled device 108 is located, the voice controlled device 108 may be caused to be blocked. In some scenarios, if a voice command from a user who is not blocked is detected (e.g., based on audio captured by the computing device 109, premises device 110, and/or user device 106), then the voice controlled device 108 may temporarily unblock the voice controlled device 108 to allow the command from the unbanned user to be transmitted and/or processed (e.g., even while the banner user is in the room).

The voice controlled device 108 may be caused (e.g., by the computing device 109, the network device 104, and/or the server device 102) to be blocked from sending data via the first network 118. Access control data 105 (e.g., or an access control list, a network configuration) may be caused to be updated to block the voice controlled device 108 from sending data via a first network 118. The access control data 105 may be caused, based on the instruction, to be updated to block the voice controlled device 108 from sending data via the first network 112. The access control data 105 may be stored in the network device 104. The access control data 105 may be updated by adding one or more rules to the access control data 105. An example rule may indicate an address (e.g., media access control address, network address) associated with the voice controlled device 108. The rule may indicate that the address is blocked (e.g., or other permission level, data cap). The rule may indicate that the address is added to a permission group. The permission group may specify network restrictions, such as blocked websites, bandwidth limits, allowed websites, and/or the like, time restrictions, and/or the like.

If the voice controlled device 108 is blocked from accessing the first network 112, the voice controlled device 108 may become unblocked. The computing device 109 may cause the voice controlled device 108 to become unblocked.

The computing device 109 may be configured (e.g., if in listening mode) to determine audio data (e.g., and/or other data such as sensor data, video data) at the premises 116. The computing device 109 may capture the data via a microphone and/or capture device of the computing device 109. The computing device 109 may be configured to process the audio data to determine if the audio data comprises a command from a user. Processing the audio data may comprise performing natural language processing, detecting keywords, performing audio fingerprint comparisons, and/or the like. The computing device 109 may determine if the audio data comprises a command from a user by identifying a trigger word. The trigger word may be a keyword associated with controlling a specific device. If the trigger word is associated with controlling the computing device 109, then the computing device 109 may process the command and send any data to execute the command to other devices at the premises 116, such as the network device 104, a premises device 110, a television, a speaker, a streaming device, and/or the like.

If the detected trigger word is associated with the voice controlled device 108, then the computing device 109 may determine if a trigger condition associated with controlling (e.g., blocking or unblocking) network access of the voice controlled device 108 exists. In some scenarios, the determining of the trigger condition may be performed by a different device, such as the network device 104, the user device 106, and/or the server device 102. In such scenario, the computing device 109 may send data indicative of captured audio to the different device, a transcription of the captured audio, and indication of the detected trigger word, and/or the like.

The trigger condition may be a trigger condition for unblocking network access of the voice controlled device 108. The trigger condition for unblocking network access may comprise detection of the trigger word associated with controlling the second device in audio data of the data captured at the premises 116. The trigger word may be a word that indicates that the user is giving a command to the voice controlled device 108. The trigger condition may comprise detection of a user (e.g., based on a sensor, camera, or based on the location of the computing device 109) in an area of the premises 116 in which the voice controlled device 108 is located. Determining the trigger condition may comprise determining an identity of a detected person. The identity may be determined based on voice analysis, image analysis, and/or other user signature (e.g., from a device, from other detected metrics).

A user profile may be accessed (e.g., locally, via the network device 104, via the server device 10) to determine permission and/or other related preferences associated with the premises 116 (e.g., and the voice controlled device 108). If the trigger condition matches a setting in the user profile, then the trigger condition may be detected and/or determined to be processed (e.g., or evaluated). The trigger condition may be specified (e.g., defined, indicated) by a user (e.g., via the user profile). The trigger condition may comprise a single condition or a combination of conditions. Weights may be applied to the conditions to determine a score. The trigger condition may be a pattern, trend, a condition detected by a machine learning model (e.g., or rule based heuristic model), or a combination thereof. The score, model output, and/or other data values (e.g., sensor data values, audio level, detected words) may be compared to one or more threshold values, ranges, word dictionaries and/or the like to determine the trigger condition.

The network device 104, the computing device 109, the server device 102, or any combination thereof may be configured to determine any trigger condition, such as a trigger condition associated with unblocking the voice controlled device 108 or a trigger condition associated with blocking the voice controlled device 108. The trigger condition associated with unblocking (e.g., or blocking) the voice controlled device 108 may be determined based on data captured at the premises 116, such as audio data, video data, sensor data, application data, or a combination thereof. Premises data captured at the premises may be received from the one or more premises devices 110. The one or more premises devices 110 may comprise a camera, proximity sensor, a motion sensor, or a combination thereof. The premises data may indicate a location of the user, an identity of the user, and/or the like. A trigger condition may be based on the location and/or the identity of a user. As a particular user moves around the premises 116, various trigger conditions may trigger blocking and/or unblocking of the voice controlled device.

The trigger condition for unblocking network access may be specified (e.g., defined, indicated) by a user. The trigger condition for unblocking network access may comprise a single condition or a combination of conditions. Weights may be applied to the conditions to determine a score. The trigger condition for unblocking network access may be a pattern, trend, a condition detected by a machine learning model (e.g., or rule based heuristic model), or a combination thereof. The score, model output, and/or other data values (e.g., sensor data values, audio level, detected words) may be compared to one or more threshold values, ranges, word dictionaries and/or the like to determine the trigger condition for unblocking network access.

The voice controlled device 108 may be caused (e.g., by the computing device 109, the network device 104, and/or the server device 102) to be unblocked from sending data via a first network 118. The access control data 105 may be caused to be updated to unblock the voice controlled device 108 from accessing the first network 112. The access control data 105 may be caused, based on the trigger condition for unblocking network access, to be updated to unblock the voice controlled device 108 from accessing the first network 112. The trigger condition for unblocking network access may comprise detection of a trigger word associated with the voice controlled device 108 in audio data captured by the computing device 109 (e.g., or user device 106, premises device 110).

Causing the access control data 105 to unblock the voice controlled device 108 may be based on a permission associated with a user. A user may be determined from a plurality of users associated with the premises. The user may be determined based on the user being associated with the trigger condition. A machine learning model (e.g., neural network) may be trained to recognize images indicative of specific users associated with the premises 116. The machine learning model may be stored and/or may be accessed by a premises device 110, the server device 102, the user device 106, the network device 104, or a combination thereof. The machine learning model may perform automated feature recognition to determine imaging features indicative of a person and/or user input. The machine learning model may be trained using a training data set comprising images of faces of a variety of people. The machine learning model may be further trained (e.g., refined) based images of faces of people identified at the premises 116, such as captured video of different users. An identified face may be associated with a specific user. Data indicative of the face may be associated with a user profile. A premises 116 may have different user profiles. The user profiles may have different corresponding categories, such as primary user, secondary user, and/or the like. Different profiles may be associated with different network access rules.

The trigger condition may comprise detection of a user in an area of the premises 116 in which the voice controlled device 108 is located. Determining the trigger condition for unblocking network access may comprise determining an identity of a detected person. The identity may be determined based on voice analysis, image analysis, and/or other user signature (e.g., from a device, from other detected metrics). A primary (e.g., parent, supervisor) user may be allowed to use the voice controlled device 108 (e.g., for voice controlled operation). A secondary user (e.g., child) may not be allowed to use the voice controlled device 108.

The network device 104 may be configured to store data from the voice controlled device 108 in a buffer (e.g., if the voice controlled device 108 is first blocked). The buffer may comprise a circular buffer, such as a buffer with a fixed size that may overwrite the oldest data with new data to make space for the new data. The buffer may comprise data intended to be sent to and/or data received from the voice controlled device 108. If the voice controlled device 108 is unblocked, then the data in the buffer for the voice controlled device 108 may be released from the buffer to cause routing of the data to the intended destination (e.g., via the first network 112 and/or via the second network 114.

The user device 106 may comprise a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device 106 may be configured to communicate with the network device 104, the server device 102, the voice controlled device 108, the computing device 109, the one or more premises devices 110, and/or the like. The user device 106 may be configured to output a user interface. The user interface may be output via the user interface via an application, service, and/or the like, such as a content browser. The user interface may receive application data from the server device 102. The application data may be processed by the user device 106 to cause display of the user interface.

The user interface may be displayed on a display of the user device 106. The display may comprise a television, screen, monitor, projector, and/or the like. The user interface may comprise a premises management application, a premises automation application, a content management application (e.g., for accessing video, audio, gaming, and/or other media), a smart assistant application, a virtual assistant application, a premises security application, network services application, or a combination thereof. The user interface may be configured to output status information associated with the premises (e.g., status information of the one or more premises device and/or network device 104). The application may be configured to allow control of and/or sending commands to the premises 116 (e.g., to the one or more premises devices 110, the voice controlled device 108, and/or the network device 104). The user interface may be configured to allow a user to configure settings associated with the network device 104, the voice controlled device, and/or the like.

FIG. 2A shows an example premises. Any of the features or elements of FIG. 1 may be incorporated in the example premises shown in FIG. 2A. In particular, FIG. 2A shows an example premises 200 of a user 202. The premises 200 may comprise a plurality of rooms (e.g., or areas), such as a sitting room 204, a dining room 206, a kitchen 208, a living room 210, and/or the like. The premises 200 may comprise one or more first computing devices 212. The one or more first computing devices 212 may comprise any of the features of the voice controlled device 108 of FIG. 1. The one or more first computing devices 212 may comprise third party devices, virtual assistant devices, voice controlled devices, a speaker, a smart speaker, a controller, and/or the like. The premises 200 may comprise a second computing device 214. The second computing device 214 may comprise any of the features of the computing device 109 of FIG. 1.

The second computing device 214 may comprise a service provider device, a controller (e.g., remote control), a virtual assistant device, a voice controlled device, a speaker, a smart speaker, a controller, a television controller, a set-top box controller, and/or the like. The one or more first computing devices 212 may recognize a different trigger word (e.g., or set of trigger words) for execution of commands than the second computing device 214.

In some scenarios, the second computing device 214 may be a voice based controller for a media device (e.g., television, set-top box, streaming device). The media device may be associated with (e.g., managed by, in communication with) a service provider that the user 202 uses to access content on the media device. The one or more first computing devices 212 may be smart speakers, such as voice controlled speakers associated with (e.g., managed by, in communication with) a third party provider that is different than the service provider. The second computing device 214 may be a device that is trusted (e.g., data indicating the trust may be stored locally, remotely, etc.) by one or more the user 202, the server device 218, the service provider, or a combination thereof.

The premises 200 may comprise a network device 216. The network device 216 may comprise the network device 104 of FIG. 1. The network device 216 may comprise a gateway, a router, a modem (e.g., a cable modem), a switch, or a combination thereof. The network device 216 may be configured to communicate (e.g., via one or more local networks, such as a wireless network, shown via dashed arrows) with any of the devices at the premises 200. The network device 216 may be configured to communicate (e.g., via a wide area network, fiber network, coaxial network, and/or the like) with devices external to the premises 200, such as server device 218 and one or more network nodes 220, and/or the like.

The user 202 may select to pause (e.g., or block) the one or more first computing devices 212. The user 202 may select to pause the one or more first computing devices 212 via an application on a user device 224 of the user 202. Note that “pause” or “block” in this context may include a scenario in which the network device 216 at the premises 200 blocks (e.g., at least temporarily) all ethernet frames being forwarded to or forwarded from a device connected to the network device 216. The blocking of the ethernet frames may be based on the device's media access control (MAC) address. This blocking may be performed using an access control list (ACL) or other similar process. In some scenarios, filtering may be applied instead of pausing. If filtering is used, only certain ethernet frames that match (e.g., or do not match) certain rules may be blocked.

The user device 224 may send (e.g., via the network device 216) data to the server devices 218 indicating a user command the pause the one or more first computing devices. The server device 218 may send data to the network device 216 to update an access control list (ACL) in the network device 216. The access control list may indicate one or more rules for blocking (e.g., or pause) ethernet frames (e.g., all ethernet frames) to/from the one or more first computing devices 212 at the premises 200. The server device 218 may be an external network based device provisioning server. The server device 218 may be configured to use various protocols, such as SNMP, WebPA, and TR-069.

The user 202 may speak a trigger word (e.g., triggering word, key word, wake word). The trigger word may be any keyword that is associated with providing a voice command to the one or more first computing devices 212. After speaking the trigger word, the user may speak a voice command. The second computing device 214 may comprise one or more microphones. The second computing device 214 may detect the spoken words of the user 202 as audio data. As an example, if a user says, “Hey voice device, what is the weather today,” then the trigger word would be “hey voice device” and the command would be “what is the weather today?”

The second computing device 214 may capture (e.g., from the room the user is in, or a different room) audio of the user speaking the command (e.g., even though the audio is intended for the one or more first computing devices 212). The second computing device 214 may process the audio to detect the trigger word. The second computing device 214 may use built in natural language processing, audio fingerprinting, and/or other like to detect the trigger word. The second computing device 214 may detect the phrase “hey voice device.” The second computing device 214 may send data to the network device 216 to cause the network device 216 to unblock the one or more first computing devices 212. The data may be an instruction to update a rule of the access control list. A media access control address may be removed from the access control list. The second computing device 214 may communicate directly with the network device 216 and/or the second computing device 214 may send the data to the server device 218. The server device may send the instruction to the network device 216 to unblock the one or more first computing devices 212.

The network device 216 may leave the one or more first computing devices 212 unblocked until a trigger condition is detected and/or matches a rule. An example trigger condition may be any combination of one or more of the following:

1) The second computing device 214 detects the trigger word again and the packets being received at the network device 216 stop for a threshold amount of time.

2) No second trigger word (e.g., the user 202 only asked for the weather) is detected but the network device 216 stops receiving packets from the one or more first computing devices 212 for a threshold amount of time.

3) The second computing device 214 detects a command indicating that the user 202 has stopped using a service of the one or more first computing devices 212. The second computing device 214 may parse a command from the user 202 (e.g., the command to the one or more first computing devices 212) to determine if the command was for a particular service, such as a streaming media service (e.g., audio service, video service). If the user speaks “play my favorite song,” then the second computing device 214 may parse the captured audio to determine the command and that the command relates to an audio service. The second computing device 214 may continue to parse any subsequently captured audio to detect a second command associated with the service, such as a stop command, pause command, end command, and/or the like that terminates use of the service.

4) The second computing device 214 (e.g., or network device 216) detects no activity or activity below a threshold for a period of time. The second computing device 214 may detect that a service (e.g., audio, video, other) starts playing (e.g., by capturing audio via the microphone) within a threshold amount of time of unpausing the one or more first computing devices 212. At some time later, the second computing device 214 detects that there is no music/other being played.

If a trigger condition is detected and/or matches a rule as described above, the network device 216 may block the one or more first computing devices 212.

The network device 216 may be configured to store all data from the one or more first computing devices 212 in a buffer (e.g., if any of the first computing devices 212 are blocked). The buffer may comprise a circular buffer, such as a buffer with a fixed size that may overwrite the oldest data with new data to make space for the new data. The buffer may comprise data to and/or from the one or more first computing devices 212 for a threshold time period. If one of the first computing devices 212 is unblocked, then the data in the buffer for the corresponding device may be released from the buffer to cause routing of the data. Data for the example command “what is the weather today” may be stored in the buffer until the one or more first computing devices 212 is unblocked. The second computing device 214 may detect the audio and send a command to the network device 216, which may unblock the one or more first computing devices 212 and cause any related data in the buffer to be forwarded to the intended destination.

The second computing device 214 may store data indicating the command from the user. The second computing device 214 may play the command back to ensure the first computing device 212 was able to process the command after it was unblocked. If a user speaks the command “hey device, play my favorite song,” then the second computing device 214 may store data indicating the command, such as audio data capturing the command, a text translation of the audio data, or a combination thereof. The network device 216 may be caused to unblock the one or more first computing devices 212 based on the data indicating the command. If the network device has unblocked the one or more first computing devices 212, the second computing device 214 (e.g., or other device, such as the network device 216, a premises device, video camera with a speaker) may output the data indicating the command from a speaker (e.g., playing from the speaker “hey device, play my favorite song.” The speaker may be integrated into the second computing device 214 or may be an external speaker of another device, such as a television. The one or more first computing devices 212 may capture audio of the command, recognize the command (e.g., as if spoken by the user), and/or cause a message to be sent (e.g., to a server associated with the device) via the network device 216 to enact the command.

The data indicating the command may be output via the speaker based on one or more rules. The one or more rules may comprise a timing rule. The second computing device 214 may listen for a response to the original command. A timer may be started upon detection of the original command (e.g., capture of the data indicating the command). If the timer reaches a threshold time, without detecting any response from the second computing device 214, then the data indicating the command may be caused to be output via the speaker.

The data indicating the command may be sent to a server associated with the one or more first computing devices 212. The server may comprise an application programing interface that allows devices not managed by a provider of the server to communicate with the server. The second computing device 214 may detect that the timer has reached the threshold time, and send a command to the server (e.g., via the application programming interface). The second computing device 214 may translate the captured audio of the command into text. The text may be processed to generate a command formatted according to a syntax associated with the application programming interface.

The user device 224 may be used to capture audio instead of or in addition to the second computing device 214. An application on the user device 224 (e.g., a trusted phone, tablet, smart device, smart watch, mobile device) may have access to a microphone of the user device 224. The application may capture audio and process the audio to listen for and/or detect trigger words. The user device 224 may send commands, audio data, and/or other information to the network device 216, the server device 218, or a combination thereof.

The network device 216 may buffer packets/frames from the one or more first computing devices 212, if blocking network access. If the second computing device 214 determines that a trigger word has been detected, the second computing device 214 causes the one or more first computing devices 212 to be unblocked by the network device 216. All of the packets/frames from the one or more first computing devices 212 that include the voice command are transmitted to the first network 112 (e.g., the network device 216 sends all of the one or more first computing device 212 packets/frames stored in a buffer). This helps with latency issues where the one or more first computing devices 212 may start to send packets/frames that contain voice commands before the network device 216 is commanded to unblock the one or more first computing devices 212.

Instead of blocking network data from a device (e.g., all ethernet frames received from a device by the network device 216), the network device 216 may process (e.g., analyze, perform deep packet inspection) the data in received data packets to determine what packets contain audio/microphone data. If a data packet is determined to have audio/microphone data, then the packet may be blocked.

FIG. 2B shows another example premises. The premises of FIG. 2B may be the same premises 200 of FIG. 2A and may include any of the devices, elements and/or features of the premises of FIG. 2A. The one or more first computing devices 212 may comprise a first computing device 212a in the living room 210 and an additional first computing device 212b in the sitting room 204. The premises 200 may comprise one or more premises devices 222, such as a first premises device 222a and a second premises device 222b. The network device 216 may be configured to communicate with the one or more premises devices 222. The network device 216 may communicate with the one or more premises devices 222 directly, via another computing device (e.g., router, gateway), via a local area network, via a wireless link, via a mesh network (e.g., comprising the plurality of premises devices 222), or a combination thereof.

The user 202 may select to pause the one or more first computing devices 212. The user may select to pause the one or more first computing devices 212 via an application on a user device 224 of the user 202.

The user device 224 may send (e.g., via the network device 216) data to the server device 218 indicating a user command to pause the one or more first computing devices. The server device 218 may send data to the network device 216 to update an access control list (ACL) in the network device 216. The access control list may indicate one or more rules for blocking (e.g., or pause) ethernet frames (e.g., all ethernet frames) to/from the one or more first computing devices 212 at the premises 200.

As shown by the arrow with small dashes, the user 202 may walk into the living room 210. The first premises device 222a may detect the user 202 entering the room. An example first premises device 222a may comprise, a video camera (e.g., IP camera) that is located in the living room 210. The first premises device 222a may send data to cause the network device 216 to unblock (e.g., temporarily unblock or un-pause) the first computing device 212a in the living room. The additional first computing device 212b in the sitting room 204 may remain blocked.

The network device 216 may leave the first computing device 212a in the living room to remain unblocked until a trigger condition is detected. The trigger condition may comprise any combination of the following conditions:

1) The first premises device 222a (e.g., the camera, or the second premises device 222b) detects the user 202 has left the living room 210 (e.g., or entered another room) and packets being received by the network device 215 associated with the first computing device 212a in the living room are not received for a threshold period of time.

2) No second trigger word (e.g., the user 202 only asked for the weather, and thus never provided a stop command) is detected and the network device 216 stops receiving packets for a period of TBD seconds.

If the trigger condition is detected, the network device 216 may block (e.g., or pause) all network traffic (e.g., all ethernet frames) to and/or from the first computing device 212a in the living room. If the user is detected in the sitting room (e.g., an unblocking trigger condition is satisfied), then the first computing device 212b in the sifting room may be unblocked.

The first premises device 222a may have a microphone and (e.g., like the second computing device 214) use audio to listen for the trigger words and/or commands from the user 202. If the first premises device 222a is unable to process the captured audio, the audio may be sent to the network device 216 and/or server device 219 for processing. The network device 216 and/or server device 218 may case the network device 216 to block and/or unblock the first computing device 212a in the living room as indicated by any triggering conditions that are satisfied by the detected audio.

Facial recognition may be used to block, unblock, and/or filter network access. An image from the first premises device 222a in the living room may be processed (e.g., using a model trained to recognize users of an account) to detect that a primary user (e.g., an adult, account holder) entered the living room 210. A set of blocking/unblock rules associated with the primary user may be used to determine whether to block, unblock, and/or filter content. If the user entering the living room is the primary user, the first premises device 222a may be unblocked. If the user entering the living room is a secondary user, such as a child, the first premises device 222a in the living room may remain blocked. Other presence detection devices may be used, such as motion sensors, radar, wireless signal detection, and/or the like to detect if someone is in a particular room and then unblock the corresponding one or more first computing devices 212 in the room.

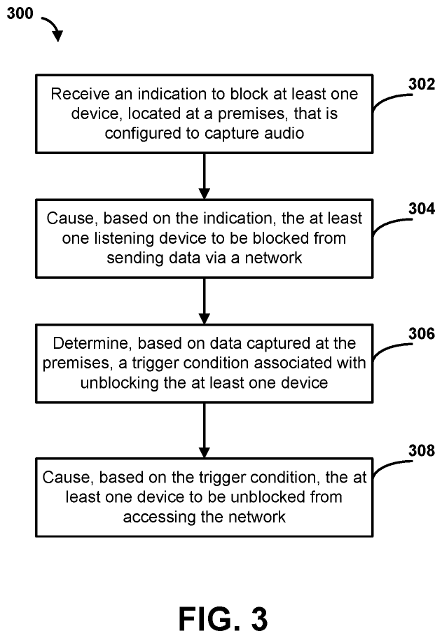

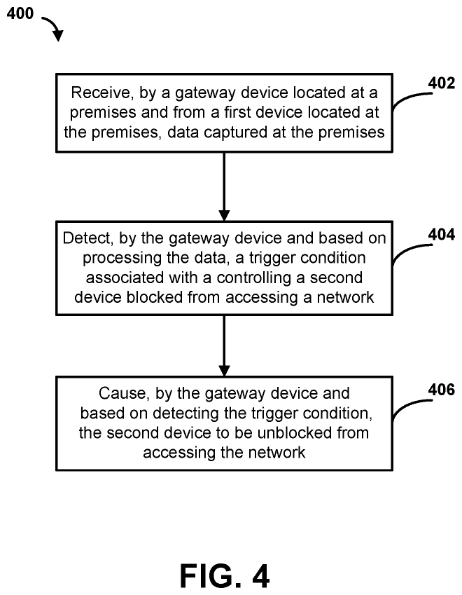

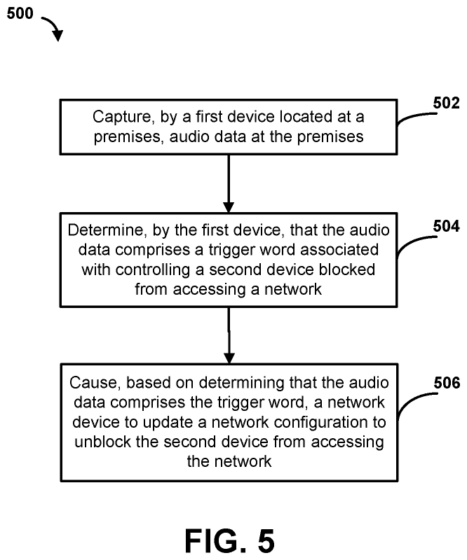

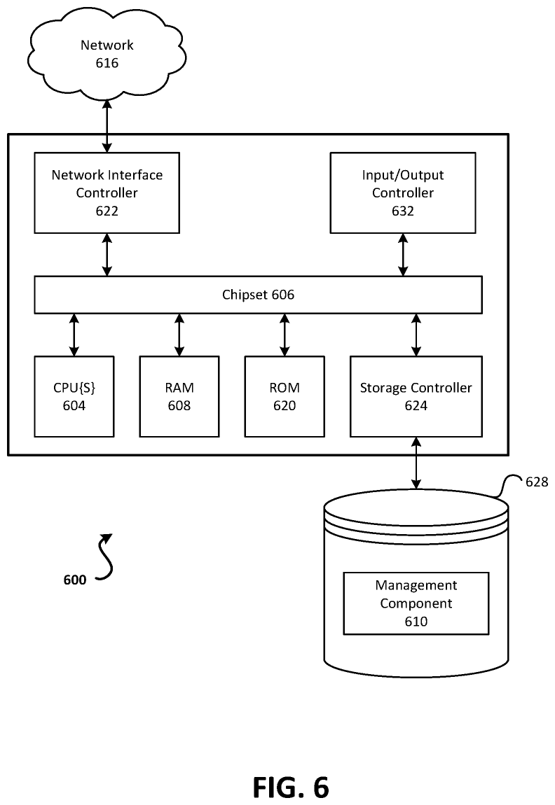

FIG. 3 shows an example method. The method 300 may comprise a computer implemented method for providing a service (e.g., a media service, a network service, a screening service, a filtering service). A system and/or computing environment, such as the system 100 of FIG. 1 and/or the computing environment of FIG. 6, may be configured to perform the method 300. The method 300 may be performed in connection with the premises and/or system illustrated in FIG. 1, FIG. 2A and FIG. 2B. Any of the features of the methods of FIGS. 4-5 may be combined with any of the features and/or steps of the method 300 of FIG. 3.

At step 302, an indication (e.g., instruction, message, data indication) to block at least one device located at a premises and configured to capture audio may be received. The indication to block the at least one device may comprise an indication from a user device to pause (e.g., or block) access, by the at least one device, to the network. The indication to block the at least one device may be based on trigger condition (e.g., first trigger condition, additional trigger condition). The trigger may comprise one or more of completion of an operation by a user, detection of music turning off, detection of the user leaving an area of the premises, a light turning off, a door opening, a change of a mode of a premises system, or an arming of the premises system.

At step 304, the at least one listening device may be caused to be blocked from sending data via the network. The at least one listening device may be caused to be blocked from sending data via the network based on the indication. An access control list (e.g., or access control data, network configuration) may be caused to be updated to cause the at least one device to be blocked from sending data via a network. The access control list may be caused, based on the indication, to be updated to block the at least one listening device from sending data via a network.

The access control list may be comprised in a gateway device (e.g., or other network device, computing device) located at the premises. The access control list may be updated by adding one or more rules to the access control list. An example rule may indicate an address (e.g., media access control address) associated with a device of the at least one device. The rule may indicate that the address is blocked (e.g., or other permission level, data cap). The rule may indicate that the address is added to a permission group. The permission group may specify network restrictions, such as blocked websites, bandwidth limits, allowed websites, and/or the like, time restrictions, and/or the like.

Causing the at least one device to be blocked (e.g., causing the access control list to block the at least one device) may be based on a permission associated with a user. A user may be determined from a plurality of users associated with the premises. The user may be determined based on the user being associated with the trigger condition. The trigger condition may comprise detection of a user in an area of the premises different from the location in which the at least one device may be located. Determining the trigger condition may comprise determining an identity of a detected person. The identity may be determined based on voice analysis, image analysis, and/or other user signature (e.g., from a device, from other detected metrics). A primary (e.g., parent, supervisor) user may be allowed to use the at least one device (e.g., for voice controlled operation). A secondary user (e.g., child) may not be allowed to use the at least one device.

At step 306, a trigger condition associated with unblocking the at least one device may be determined. The trigger condition associated with unblocking the at least one device may be determined based on data captured at the premises, such as audio data, video data, sensor data, application data, or a combination thereof. Data captured at the premises may be received from one or more premises devices. The one or more premises devices may comprise a camera, proximity sensor, a motion sensor, or a combination thereof.

The trigger condition may be specified (e.g., defined, indicated) by a user. The trigger condition may comprise a single condition or a combination of conditions. Weights may be applied to the conditions to determine a score. The trigger condition may be a pattern, trend, a condition detected by a machine learning model (e.g., or rule based heuristic model), or a combination thereof. The score, model output, and/or other data values (e.g., sensor data values, audio level, detected words) may be compared to one or more threshold values, ranges, word dictionaries and/or the like to determine the trigger condition.

At step 308, the at least one device may be caused to be unblocked from accessing the network. The at least one device may be caused to be unblocked from accessing the network based on (e.g., in response to detecting) the trigger condition. The access control list may be caused to be updated to cause the at least one device to be unblocked from accessing the network. The access control list may be caused, based on the trigger condition, to be updated to unblock the at least one device from accessing the network. The trigger condition may comprise detection of a trigger word associated with the at least one device in audio data captured by another device located at the premises.

Causing the at least one device to be unblocked from accessing the network (e.g., or causing the access control list to unblock the at least one device) may be based on a permission associated with a user. A user may be determined from a plurality of users associated with the premises. The user may be determined based on the user being associated with the trigger condition. The trigger condition may comprise detection of a user in an area of the premises in which the at least one device may be located. Determining the trigger condition may comprise determining an identity of a detected person. The identity may be determined based on voice analysis, image analysis, and/or other user signature (e.g., from a device, from other detected metrics). A primary (e.g., parent, supervisor) user may be allowed to use the at least one device (e.g., for voice controlled operation). A secondary user (e.g., child) may not be allowed to use the at least one device.

A gateway device (e.g., or other network device, computing device) located at the premises may be configured to store data from the at least one device in a buffer. Causing the access control list to be updated to unblock may cause the data to be sent via the network.

FIG. 4 shows an example method. The method 400 may comprise a computer implemented method for providing a service (e.g., a media service, a network service, a screening service, a filtering service). A system and/or computing environment, such as the system 100 of FIG. 1 and/or the computing environment of FIG. 6, may be configured to perform the method 400. The method 400 may be performed in connection with the premises and/or system illustrated in FIG. 1, FIG. 2A and FIG. 2B. Any of the features of the methods of FIG. 3 and FIG. 5 may be combined with any of the features and/or steps of the method 400 of FIG. 4.

At step 402, data captured at the premises may be received. The data captured at the premises may be received by a gateway device located at a premises. The data captured at the premises may be received from a first device located at the premises. The first device may be one or more of a premises device, voice controlled device, a camera, a proximity sensor, or a motion sensor. The first device may have a microphone in a listening mode (e.g., active or passive listening). The microphone may generate the data captured at the premises if a sound (e.g., above a threshold noise level) is detected. The first device may process the data by translating the data captured into text information. The data captured at the premises may be received as and/or include the text information.

At step 404, a trigger condition associated with controlling a second device may be detected. The trigger condition associated with controlling (e.g., blocking, unblocking) the second device may be detected by the gateway device. The trigger condition associated with controlling the second device may be detected based on processing the data. The data may be translated to text information (e.g., if not already translated). Words may be identified in the text information. The words may be compared to words associated with trigger conditions.

The trigger condition may comprise detection of a trigger word associated with controlling the second device in audio data of the data captured at the premises. The trigger word may be a word that indicates to the second device that the user is giving a command to the second device. The trigger condition may comprise detection of a user in an area of the premises in which the second device may be located. Determining the trigger condition may comprise determining an identity of a detected person. The identity may be determined based on voice analysis, image analysis, and/or other user signature (e.g., from a device, from other detected metrics).

A user profile may be accessed (e.g., via a server) to determine permission and/or other related preferences associated with the premises (e.g., and the second device). If the trigger condition matches a setting in the user profile, than the trigger condition may be detected and/or determined to be processed (e.g., or evaluated). The trigger condition may be specified (e.g., defined, indicated) by a user (e.g., via the user profile). The trigger condition may comprise a single condition or a combination of conditions. Weights may be applied to the conditions to determine a score. The trigger condition may be a pattern, trend, a condition detected by a machine learning model (e.g., or rule based heuristic model), or a combination thereof. The score, model output, and/or other data values (e.g., sensor data values, audio level, detected words) may be compared to one or more threshold values, ranges, word dictionaries and/or the like to determine the trigger condition.

The second device may be located at the premises. The second device may be blocked from accessing a network. The second device may be blocked by the gateway device. The second device may be blocked based on a network configuration (e.g., stored at the gateway device, a server device, the first device, or a combination thereof). The network configuration may comprise data stored in access control data, an access control list, routing data, or a combination thereof. The network configuration may comprise an access control list stored in the gateway device. The network configuration blocking the second device from accessing the network may be based on an additional trigger condition. The additional trigger condition may comprise one or more of completion of an operation by a user, detection of music turning off, detection of the user leaving an area of the premises, a light turning off, a door opening, a change of a mode of a premises system, or an arming of the premises system. In some scenarios, an indication (e.g., instruction, message, data indication) to block the second device may be received. The indication may be received by the gateway device. The indication may be received based on a user command. The network configuration may be based on the indication.

At step 406, the second device may be caused to be unblocked. An update may be caused to the network configuration to unblock the second device from accessing the network. The update may be caused to the network configuration to unblock the second device from accessing the network. The second device may be caused to be unblocked by the gateway device. The update may be caused by the gateway device. The second device may be caused to be unblocked based on detecting the trigger condition. The update may be caused based on detecting the trigger condition.

A user, of a plurality of users associated with the premises, associated with the trigger condition may be determined. Causing the second device to be unblocked (e.g., the update to the network configuration) from accessing the network may be based on a permission associated with the user. Data from the second device may be stored (e.g., by the gateway device) in a buffer. Causing the second device to be unblocked (e.g., causing the update to the network configuration) may cause the data to be sent via the network. If a user speaks a wake word for the second device, the second device may process any instructions following the wake word and send data to implement the instructions to a server. If the second device is blocked, the data may be stored in the buffer for a time period.

FIG. 5 shows an example method. The method 500 may comprise a computer implemented method for providing a service (e.g., a media service, a network service, a screening service, a filtering service). A system and/or computing environment, such as the system 100 of FIG. 1 and/or the computing environment of FIG. 6, may be configured to perform the method 500. The method 500 may be performed in connection with the premises and/or system illustrated in FIG. 1, FIG. 2A and FIG. 2B. Any of the features and/or steps of the methods of FIGS. 3-4 may be combined with any of the features of the method 500 of FIG. 5.

At step 502, audio data at the premises may be captured. The audio data at the premises may be captured by a first device located at a premises. The first device may comprise one or more of a voice controlled device, a microphone device, a camera device, or a remote control device. The first device may have a microphone in a listening mode (e.g., active or passive listening). The microphone may generate the audio data captured at the premises if a sound (e.g., above a threshold noise level) is detected. The first device may process the data by translating the data captured into text information.

At step 504, a determination may be made that the audio data comprises a trigger word associated with controlling a second device located at the premises. The determination may be made by the first device. The audio data may comprise a trigger word associated with a controlling a second device located at the premises. Words (e.g., keywords, phrases) may be identified in the text information. The words may be compared to words associated with trigger conditions.

The second device may be blocked from sending data via a network based on a network configuration associated with the premises. An indication (e.g., instruction, message, data indicating) to block the second device may be sent to the network device. The indication may be sent by the first device (e.g., or another device, such as a user device and/or server device). The indication may be sent based on a user command. The network configuration may be based on the indication. The network configuration blocking the second device from accessing the network may be based on a trigger condition (e.g., first trigger condition, additional trigger condition) for blocking access. The trigger condition for blocking access may comprise one or more of completion of an operation by a user, detection of music turning off, detection of the user leaving an area of the premises, a light turning off, a door opening, a change of a mode of a premises system, or an arming of the premises system. The network configuration may comprise an access control list (e.g., or access control data, routing data) stored in the network device.

At step 506, a network device located at the premises may be caused to update a network configuration to unblock the second device from accessing the network. The network device located at the premises may be caused to update a network configuration to unblock the second device from accessing the network based on determining that the audio data comprises the trigger word.

The network device may be configured to store data from the second device in a buffer. Causing the network device to update the network configuration to unblock the second device from accessing the network may cause the data to be sent via the network. A user, of a plurality of users associated with the premises, associated with the audio data may be determined. Causing the update to the network configuration to unblock the second device from accessing the network may be based on a permission associated with the user.

FIG. 6 depicts a computing device that may be used in various aspects, such as the servers and/or devices depicted in FIGS. 1, and 2A-B. With regard to the example architecture of FIG. 1, the server device 102, network device 104, user device 106, the voice controlled device 108, and the one or more premises devices 110 may each be implemented in an instance of a computing device 600 of FIG. 6. With regard to the example architecture of FIG. 2A-B, one or more first computing devices 212, the second computing device 214, the network device 216, the server device 218, network nodes 220, the one or more premises devices 222, the user device 224 may each be implemented in an instance of a computing device 600 of FIG. 6.

The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1, FIG. 2A-B, FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 1, FIG. 2A-B, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving an indication to block at least one device, located at a premises, that is configured to capture audio;
causing, based on the indication, the at least one device to be blocked from sending data via a network;
determining, based on data captured at the premises, a trigger condition associated with unblocking the at least one device; and
causing, based on the trigger condition, the at least one device to be unblocked from accessing the network.

2. The method of claim 1, wherein the trigger condition comprises detection of a trigger word associated with the at least one device in audio data captured by another device located at the premises.

3. The method of claim 1, further comprising receiving the data captured at the premises from one or more of a camera, proximity sensor, or a motion sensor, wherein the trigger condition comprises detection of a user in an area of the premises in which the at least one device is located.

4. The method of claim 1, wherein a gateway device located at the premises is configured to store data from the at least one device in a buffer, wherein causing the access control list to be updated to unblock causes the data to be sent via the network.

5. The method of claim 1, wherein the indication to block the at least one device comprises an indication from a user device to pause access, by the at least one device, to the network.

6. The method of claim 1, wherein the indication to block the at least one device is based on an additional trigger condition comprising one or more of completion of an operation by a user, detection of music turning off, detection of the user leaving an area of the premises, a light turning off, a door opening, a change of a mode of a premises system, or an arming of the premises system.

7. The method of claim 1, wherein causing the at least one device to be blocked from sending data via a network comprises causing an access control list of a network device to be updated to block the at least one device.

8. A method comprising:
receiving, by a gateway device located at a premises and from a first device located at the premises, data captured at the premises;
detecting, by the gateway device and based on processing the data, a trigger condition associated with controlling a second device, wherein the second device is located at the premises and blocked, by the gateway device, from accessing a network; and
causing, by the gateway device and based on detecting the trigger condition, the second device to be unblocked from accessing the network.

9. The method of claim 8, wherein the trigger condition comprises detection of a trigger word associated with controlling the second device in audio data of the data captured at the premises.

10. The method of claim 8, wherein the first device is one or more of a camera, a proximity sensor, or a motion sensor, wherein the trigger condition comprises detection of a user in an area of the premises in which the second device is located.

11. The method of claim 8, further comprising storing, by the gateway device, data from the second device in a buffer, wherein causing the second device to be unblocked causes the data to be sent via the network.

12. The method of claim 8, further comprising receiving, by the gateway device and based on a user command, an indication to block the second device, wherein the second device is blocked based on the indication.

13. The method of claim 8, wherein the network configuration blocking the second device from accessing the network is based on an additional trigger condition comprising one or more of completion of an operation by a user, detection of music turning off, detection of the user leaving an area of the premises, a light turning off, a door opening, a change of a mode of a premises system, or an arming of the premises system.

14. The method of claim 8, further comprising determining a user, of a plurality of users associated with the premises, associated with the trigger condition, wherein the causing the second device to be blocked from accessing the network is based on a permission associated with the user.

15. A method comprising:
capturing, by a first device located at a premises, audio data at the premises;
determining, by the first device, that the audio data comprises a trigger word associated with controlling a second device located at the premises, wherein the second device is blocked from sending data via a network based on a network configuration associated with the premises; and
causing, based on determining that the audio data comprises the trigger word, a network device located at the premises to update a network configuration to unblock the second device from accessing the network.

16. The method of claim 15, the first device comprises one or more of a voice controlled device, a microphone device, a camera device, or a remote control device.

17. The method of claim 15, wherein the network device is configured to store data from the second device in a buffer, wherein causing the network device to update the network configuration to unblock the second device from accessing the network causes the data to be sent via the network.

18. The method of claim 15, further comprising sending, by the first device and based on a user command, an indication to block the second device, wherein the network configuration is based on the indication.

19. The method of claim 15, wherein the network configuration blocking the second device from accessing the network is based on an additional trigger condition comprising one or more of completion of an operation by a user, detection of music turning off, detection of the user leaving an area of the premises, a light turning off, a door opening, a change of a mode of a premises system, or an arming of the premises system.

20. The method of claim 15, further comprising determining a user, of a plurality of users associated with the premises, associated with the audio data, wherein the causing the update to the network configuration to unblock the second device from accessing the network is based on a permission associated with the user.
